(19) United States
(12) Patent Application Publication
(10) Pub. No.: US 2018/0078333 A1
(43) Pub. Date: Mar. 22, 2018

(54) DENTAL IMPLANT SURGICAL GUIDE

(71) Applicant: Hector Hugo Velez, New Braunfels, TX (US)

(72) Inventor: Hector Hugo Velez, New Braunfels, TX (US)

(21) Appl. No.: 15/826,920

(22) Filed: Nov. 30, 2017

Related U.S. Application Data
(63) Continuation-in-part of application No. 29/575,444, filed on Aug. 25, 2016.

(51) Int. Cl. A61C 1/08; A61C 8/00; A61C 19/04

(52) U.S. Cl. CPC A61C 1/084; A61C 19/04; A61C 8/0089

(57) ABSTRACT

A dental implant surgical guide device and method for guiding a surgical bur to a center location adjacent to at least one tooth during placement of an implant are presented. The dental implant surgical guide device may include a triangular body portion that may be inserted in a gap between two teeth, and a channel portion formed through the center of the body portion to allow the surgical bur to pass through the channel portion without contacting the body portion. Accordingly, a drill hole, and thus the implant, may be placed at the optimal, center location between the two teeth adjacent to the gap, and a distance between the two teeth may be accurately determined.

### CROSS-REFERENCE TO RELATED APPLICATIONS

This application claims benefit of priority from U.S. Design Pat. Application No. 29/575,444 filed on Aug. 25, 2016, the disclosure of which is incorporated herein by reference in its entirety.

### BACKGROUND OF THE INVENTION

### 1. Field of Invention

The present invention relates generally to the field of surgical devices. More particularly, the present invention relates to a dental implant surgical guide device and method for guiding a surgical bur to a center location adjacent to at least one tooth, and for measuring a distance between two teeth.

### 2. Description of Related Art

Traditionally, it is difficult for an oral surgeon to locate a center point between two teeth for an implant. A surgeon may visually approximate the location, which is not always accurate due at least in part to a limited field of view or angle of view, and may result in an implant being poorly centered for best hard and soft tissue support.

Current attempts have been made to create a surgical guide to address this issue. For example, U.S. Pat. No. 6,347,940 B1 to Gordils Wallis describes an instrument for a process of verifying space between teeth. However, this design fails to indicate the exact distance between two points (e.g., adjacent teeth), thus the surgeon may not be able to accurately determine the size (e.g., diameter) of implant that may be used.

Another attempt is described in UK Patent Application GB 2497550 A to Gauld et al. An apparatus is shown as including a slot into which a marking device, such as a scalpel, is inserted through the slot to mark a patient's gum to indicate a drilling position. However, the soft tissue of the gum is moveable, and therefore any marks thereon may not be accurate or useable. For example, the marked tissue will be moved completely out of the way after reflection of a soft tissue flap for access to the bone.

Based on the foregoing, there is a need in the art for a device to aid a surgeon in location of a center point between two teeth, or the center point for the placement of an implant adjacent to a tooth, before or after reflection of a soft tissue flap. There is also a need in the art for a device to accurately determine a distance between two teeth so that a surgeon can quickly and accurately determine an ideal size or diameter of an implant to be used.

The above problems in the related art are considered as matters that have been addressed by the inventor to derive the present inventive concept, or as matters discovered during the course of deriving the present inventive concept. Thus, the problems may not be simply referred to as information that was known to the general public prior to filing the present disclosure.

### SUMMARY OF THE INVENTION

One or more exemplary embodiments of the present invention include a dental implant surgical guide device for guiding a surgical bur to a center location adjacent to at least one tooth during placement of an implant. The dental implant surgical guide device may include a triangular body portion having a first tapered side, a second tapered side, and a base side, wherein at least one of the first tapered side and the second tapered side abuts the at least one tooth; and a channel portion formed through the body portion and extending in a direction perpendicular to the base side, wherein the channel portion is formed having a width in a direction parallel to the base side sufficient to allow the surgical bur to pass through the channel portion without contacting the body portion.

In an exemplary embodiment, the dental implant surgical guide device may include a plurality of first markings on the body portion adjacent to the channel portion, wherein each of the plurality of first markings corresponds to a width of the body portion from the first tapered side to the second tapered side at each respective first marking in a direction parallel to the base side.

In another exemplary embodiment, each of the plurality of first markings may comprise a number equaling the width of the body portion at each respective first marking in millimeters.

In another exemplary embodiment, the number may be one of 2, 3, 4, 5, 6, 7, 8, 9, 10, 11, 12, 13, 14, and 15.

In another exemplary embodiment, the plurality of first markings may comprise numbers 2, 3, 4, 5, 6, 7, 8, 9, 10, 11, 12, 13, 14, and 15.

In another exemplary embodiment, the channel portion may have an oblong shape.

In another exemplary embodiment, the channel portion may have a length of 37.25 millimeters in the direction perpendicular to the base side.

In another exemplary embodiment, the channel portion may have a width of 2.5 millimeters in a direction parallel to the base side.

In another exemplary embodiment, the body portion may be formed of a flat sheet.

In another exemplary embodiment, the body portion may be formed of stainless steel, tempered spring steel, or plastic.

In another exemplary embodiment, the body portion may have a thickness of 0.71 millimeters.

In another exemplary embodiment, the body portion may have a thickness of 3 to 4 millimeters.

In another exemplary embodiment, the first tapered side and the second tapered side may form an angle of 14.25°.

One or more exemplary embodiments of the present invention include a method for guiding a surgical bur to a center location adjacent to at least one tooth during placement of an implant using a dental implant surgical guide device including a triangular body portion having a first tapered side, a second tapered side, and a base side; and a channel portion formed through the body portion and extending in a direction perpendicular to the base side. The method may include positioning the dental implant surgical guide device such that at least one of the first tapered side and the second tapered side abuts the at least one tooth; passing the surgical bur through the channel portion without contacting the body portion to drill a hole; and drilling the hole.

In an exemplary embodiment, the positioning may further include positioning the dental implant surgical guide device such that the first tapered side abuts a first tooth and the second tapered side abuts a second tooth, and the at least one tooth comprises the first tooth and the second tooth.

In another exemplary embodiment, the method may further include reflecting a soft tissue flap prior to positioning the dental device.

Accordingly, the dental implant surgical guide device according to one or more exemplary embodiments of the present invention may guide a surgical bur to drill a hole at an optimal, center location adjacent to at least one tooth (or between two teeth) during placement of an implant, and may also accurately measure a distance between two teeth for quickly determining an ideal size of an implant to be placed.

The foregoing, and other features and advantages of the invention, will be apparent from the following, more particular description of the exemplary and preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view showing an example configuration of a dental implant surgical guide device according to an exemplary embodiment of the present invention.

FIG. 2 is a plan view showing the example configuration of the dental implant surgical guide device according to the exemplary embodiment of the present invention.

FIG. 3 is a plan view showing the example configuration of the dental implant surgical guide device according to the exemplary embodiment of the present invention.

FIG. 4 is a side view showing the example configuration of the dental implant surgical guide device according to the exemplary embodiment of the present invention.

FIG. 5 is a side view showing the example configuration of the dental implant surgical guide device according to the exemplary embodiment of the present invention.

FIG. 6 is a top view showing the example configuration of the dental implant surgical guide device according to the exemplary embodiment of the present invention.

FIG. 7 is a bottom view showing the example configuration of the dental implant surgical guide device according to the exemplary embodiment of the present invention.

FIG. 8 is a perspective view showing an example configuration of the dental implant surgical guide device according to another exemplary embodiment of the present invention.

FIG. 9 is a flowchart illustrating a method for guiding a surgical bur to a center location adjacent to at least one tooth during placement of an implant according to an exemplary embodiment of the present invention.

FIG. 10 is a flowchart illustrating a method for guiding a surgical bur to a center location adjacent to at least one tooth during placement of an implant according to another exemplary embodiment of the present invention.

### DETAILED DESCRIPTION OF EMBODIMENTS

Embodiments of the invention are discussed below with reference to the figures. However, those skilled in the art will readily appreciate that the detailed description given herein with respect to these figures is for explanatory purposes as the invention extends beyond these limited, exemplary embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following exemplary embodiments described and shown. That is, there are numerous modifications and variations of the invention that are too numerous to be listed but that all fit within the scope of the invention.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems as does the present invention.

Features that are described in the context of separate embodiments may also be provided in combination in a single embodiment. Conversely, various features that are, for brevity, described in the context of a single embodiment, may also be provided separately or in any suitable subcombination. New claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art, many careful considerations and compromises typically must be made when designing for the optimal manufacture of a commercial implementation any system, and in particular, the exemplary embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

As will be understood by one skilled in the art, all ranges recited herein also encompass any and all possible sub-ranges and combinations of sub-ranges thereof, as well as the individual values making up the range, particularly integer values. Any listed range can be easily recognized as sufficiently describing and enabling the same range being broken down into at least equal halves, thirds, quarters, fifths, or tenths. A recited range (e.g., weight percent, absolute weight) includes each specific value, integer, decimal, or identity within the range. As will also be understood by one skilled in the art, all language such as “up to,” “at least,” greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specified values recited for radicals, substituents, and ranges, are for illustration only; they do not exclude other defined values or other values within defined ranges for radicals and substituents.

The present invention will now be described in detail with reference to exemplary embodiments thereof as illustrated in the accompanying drawings, wherein like reference numerals refer to like elements.

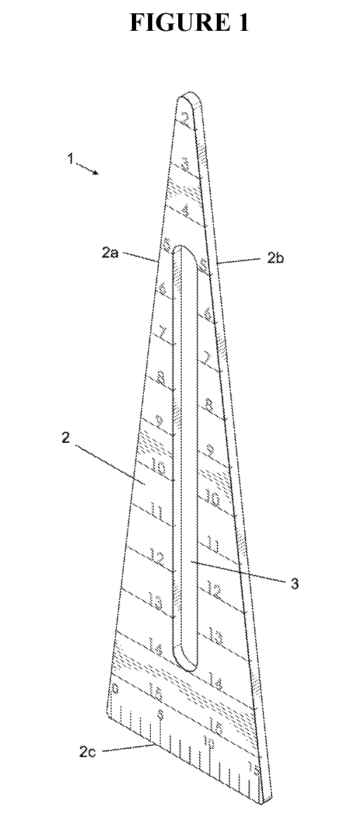

FIG. 1 illustrates a perspective view of a dental implant surgical guide device 1 according to an exemplary embodiment of the present invention.

Referring to FIG. 1, a dental implant surgical guide device 1 according to an exemplary embodiment comprises a triangular, wedge-shaped body portion 2. The body portion 2 may be formed from a flat sheet of metal, such as stainless steel, tempered spring steel, or a plastic material that is able to be heat sterilized for re-use. In an embodiment, the body portion 2 may have a thickness of 0.71 mm.

The body portion 2 includes a pair of tapered sides 2a and 2b, and a base side 2c. In a preferred embodiment, the body portion 2 forms an isosceles triangle with the pair of tapered sides 2a and 2b having equal length. In another preferred embodiment, the pair of tapered sides 2a and 2b forms an angle of 14.25°.

The dental implant surgical guide device 1 includes an oblong-shaped channel portion 3 formed through the center of the body portion 2, thus bisecting body portion 2. The channel portion 3 extends the length of the body portion 2 (i.e., in a direction perpendicular to the base side 2c). The channel portion 3 is sufficiently wide to allow a surgical bur (drill) to pass through the channel portion 3 without contacting the body portion 2. For example, the width of the channel portion 3 may be 2 to 3 mm. In a preferred embodiment, the width of the channel portion 3 is 2.5 mm and the length of the channel portion 3 is 37.25 mm. Accordingly, a surgical bur with a diameter of 2 to 2.2 mm for creating the implant osteotomy may be guided through the channel portion 3 without contacting the body portion 2.

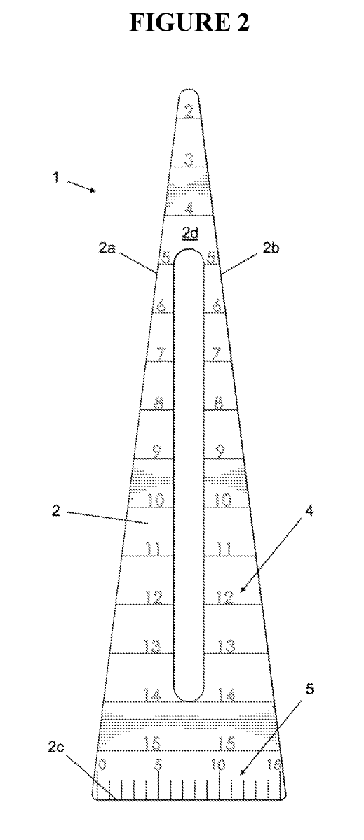

FIG. 2 illustrates a plan view of the front of the dental implant surgical guide device 1 according to the exemplary embodiment of the present invention.

Referring to FIG. 2, the body portion 2 has a front face 2d that includes a plurality of first markings 4, where each of the plurality of first markings 4 includes a line and a corresponding number. The plurality of first markings 4 has a functional relationship with the physical dimensions of the body portion 2. Particularly, each line extends parallel to the base side 2c, and each number indicates a width in millimeters of the body portion 2 at the corresponding line from one tapered side to the other. For example, the width of the body portion 2 at the line corresponding to “5” is 5 mm, and the width of the body portion 2 at the line corresponding to “12” is 12 mm. In an exemplary embodiment, the plurality of first markings 4 include the numbers “2,” “3,” “4,” “5,” “6,” “7,” “8,” “9,” “10,” “11,” “12,” “13,” “14,” and “15”and respective lines for each number. However, fewer or additional such markings may also exist as appropriate depending on the dimensions of the body portion 2, so long as the functional relationship is maintained. The first markings 4 may be printed onto the body portion 2 in any suitable manner, such as by laser etching or painting. Each of the plurality of first markings 4 may be printed in singularity on the front face 2d, or one or more of the plurality of first markings 4 may be printed on the front face 2d in plurality, such as on either side of the channel portion 3.

In an exemplary embodiment, the front face 2d may also include second markings 5, where each of the plurality of second markings 5 includes a line and may also include a corresponding number. The plurality of second markings 5 has a functional relationship with the physical dimensions of the body portion 2. Particularly, each line is spaced 1 mm apart along the base side 2c, and each number indicates a distance in millimeters along the base side 2c from a reference (e.g., 0 mm). The second markings 5 may be printed onto the body portion in any suitable manner, such as by laser etching or painting.

In an exemplary embodiment, a surgeon may place the dental implant surgical device 1 such that at least one of the tapered sides 2a and 2b rests against a patient's tooth. Preferably, the dental implant surgical guide device 1 is inserted into a gap between two teeth where an implant is to be placed such that one tapered side 2a abuts one tooth adjacent to the gap and the other tapered side 2b abuts another tooth adjacent to the gap. Accordingly, the channel portion 3 will expose a center location between the two teeth and guide a surgical bur as it passes through to form a hole in the bone either before or after reflection of a soft tissue flap. Additionally, a distance between the two teeth may be indicated by the first marking(s) 14 adjacent to the drill hole and/or the two teeth. Advantageously, the hole, and thus the implant, may be placed at the optimal, center location between the two teeth adjacent to the gap. The surgeon may also accurately determine a distance between the two teeth, and thus be able to quickly determine an ideal size of an implant to be placed.

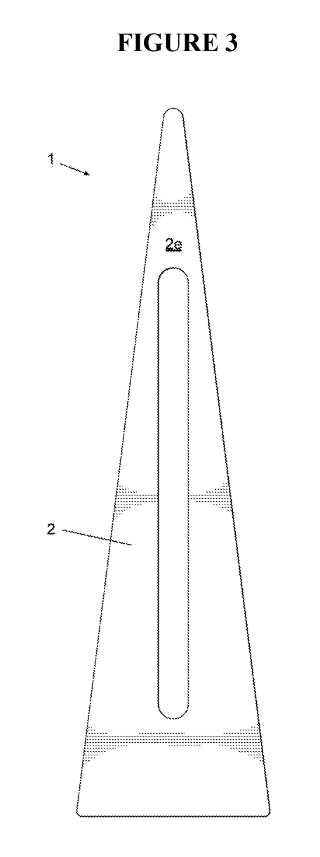

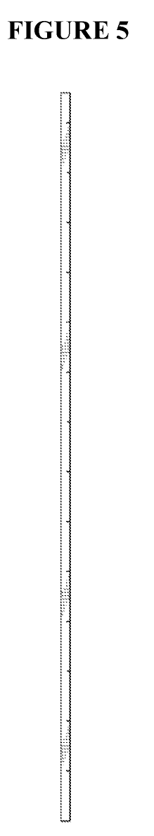

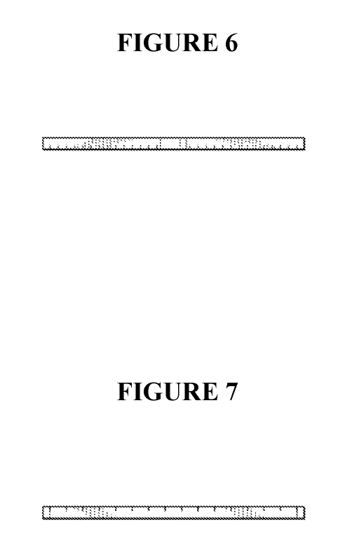

FIGS. 3-6 illustrate other views of the example configuration the dental implant surgical guide device 1 according to the exemplary embodiment of the present invention.

Referring to FIG. 3, body portion 2 includes a rear face 2e. In a preferred embodiment, the dental implant surgical guide device 1 may be inserted into a gap between two teeth such that the rear face 2e may rest on the patient's gum or bone.

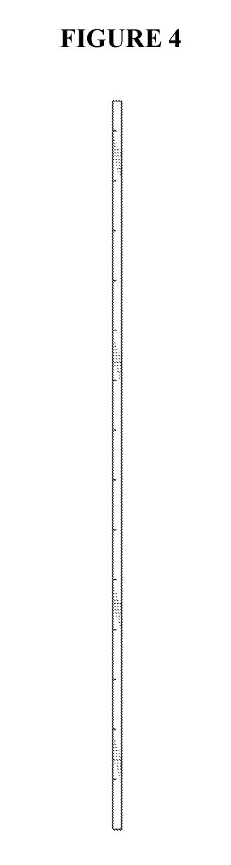

Referring to FIGS. 4-7, they illustrate right side, left side, top, and bottom views of the example configuration of the dental implant surgical guide device 1, respectively.

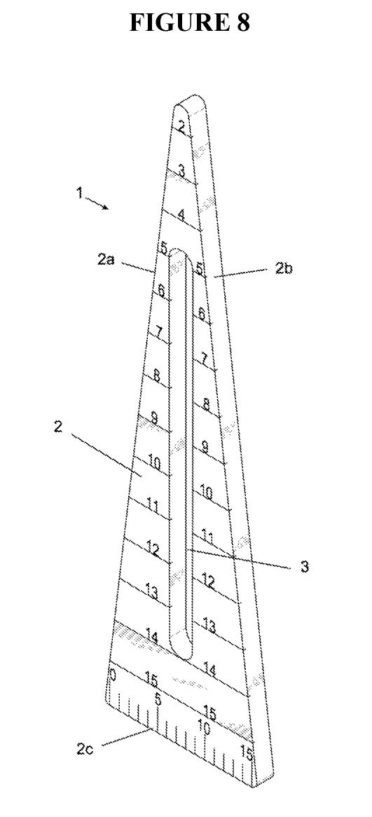

FIG. 8 is a perspective view of an example configuration the dental implant surgical guide device 1 according to another exemplary embodiment of the present invention. In FIG. 8, the same reference numerals as those of FIG. 1 denote the same elements. Thus, the differences of the exemplary embodiment(s) illustrated with reference to FIG. 8 from the exemplary embodiment(s) illustrated with reference to FIG. 1 will be described below

Referring to FIG. 8, the body portion 2 may have a thickness of 3 to 4 mm, which allows for a more exact emergence of the resultant dental implant. Particularly, a thicker body portion 2 allows the surgical bur for creating the implant osteotomy to be more accurately guided at the correct angle and position between the teeth at the bone level as well as the occlusal (chewing surface) level. This result is significant in a case of an implant space where one or both adjacent teeth have tipped and impinged on an extracted tooth space.

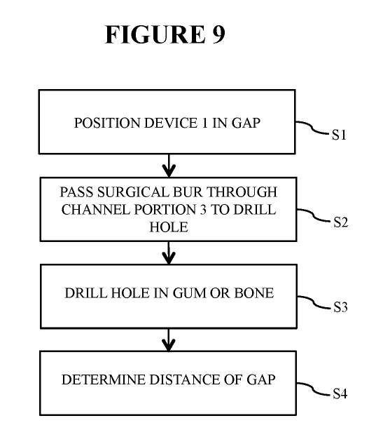

FIG. 9 is a flowchart illustrating a method for guiding a surgical bur to a center location adjacent to at least one tooth during placement of an implant according to an exemplary embodiment of the present invention.

Referring to FIG. 9, the dental implant surgical guide device 1 is first positioned in a gap in a patient's mouth where a dental implant is to be placed (step S1). Positioning may include abutting at least one tapered side 2a or 2b to at least one tooth adjacent to the gap. In a preferred embodiment, the dental implant surgical guide device 1 is positioned in the gap such that one tapered side 2a abuts one tooth adjacent to the gap, the other tapered side 2b abuts another tooth adjacent to the gap, and the rear face 2e rests against the patient's gum or bone. Accordingly, the channel portion 3 will expose a center location between the two teeth and guide a surgical bur as it passes through to form a hole in the bone either before or after reflection of a soft tissue flap.

Next, the surgical bur is passed through the center channel 3 without contacting the body portion 2 to drill a hole in the patient's gum or bone (step S2). After the hole is drilled in the patient's gum or bone (step S3), the distance the gap (i.e., the distance between the two teeth adjacent to the gap) may be determined using the first marking(s) 14 adjacent to the drill hole and/or the two teeth (step S4). Advantageously, the hole, and thus the implant, may be placed at the optimal, center location between the two teeth adjacent to the gap. The surgeon may also accurately determine a distance between the two teeth, and thus be able to quickly determine an ideal size of an implant to be placed.

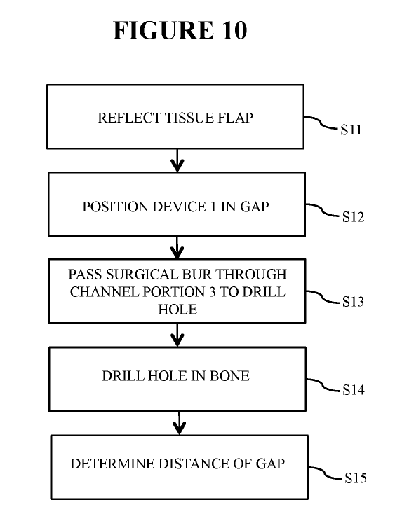

FIG. 10 is a flowchart illustrating a method for guiding a surgical bur to a center location adjacent to at least one tooth during placement of an implant according to another exemplary embodiment of the present invention.

Referring to FIG. 10, a soft tissue flap where a dental implant is to be placed is first reflected to reveal the underlying bone (step S11). Then dental implant surgical guide device 1 is positioned in a gap in a patient's mouth where the dental implant is to be placed (step S12). Positioning may include abutting at least one tapered side 2a or 2b to at least one tooth adjacent to the gap. In a preferred embodiment, the dental implant surgical guide device 1 is positioned in the gap such that one tapered side 2a abuts one tooth adjacent to the gap, the other tapered side 2b abuts another tooth adjacent to the gap, and the rear face 2e rests against the patient's bone. Accordingly, the channel portion 3 will expose a center location between the two teeth and guide a surgical bur as it passes through to form a hole in the bone after reflection of the soft tissue flap.

Next, the surgical bur is passed through the center channel 3 without contacting the body portion 2 to drill a hole in the patient's bone (step S13). After the hole is drilled in the patient's gum or bone (step S14), the distance the gap (i.e., the distance between the two teeth adjacent to the gap) may be determined using the first marking(s) 14 adjacent to the drill hole and/or the two teeth (step S15). The advantages of the method described with reference to FIG. 9 are similar to those of the method described with reference to FIG. 8, such as optimal center location placement of the hole as well as accurate distance determination. Additionally, drilling the hole after reflection of the flap may allow for increased accuracy of center location placement.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A dental implant surgical guide device for guiding a surgical bur to a center location adjacent to at least one tooth during placement of an implant, the device comprising:
a triangular body portion having a first tapered side, a second tapered side, and a base side, wherein at least one of the first tapered side and the second tapered side abuts the at least one tooth; and
a channel portion formed through the body portion and extending in a direction perpendicular to the base side, wherein the channel portion is formed having a width in a direction parallel to the base side sufficient to allow the surgical bur to pass through the channel portion without contacting the body portion.

2. The dental implant surgical guide device according to claim 1, wherein the device further comprises a plurality of first markings on the body portion adjacent to the channel portion, wherein each of the plurality of first markings corresponds to a width of the body portion from the first tapered side to the second tapered side at each respective first marking in a direction parallel to the base side.

3. The dental implant surgical guide device according to claim 2, wherein each of the plurality of first markings comprises a number equaling the width of the body portion at each respective first marking in millimeters.

4. The dental implant surgical guide device according to claim 3, wherein the number is one of 2, 3, 4, 5, 6, 7, 8, 9, 10, 11, 12, 13, 14, and 15.

5. The dental implant surgical guide device according to claim 3, wherein the plurality of first markings comprises numbers 2, 3, 4, 5, 6, 7, 8, 9, 10, 11, 12, 13, 14, and 15.

6. The dental implant surgical guide device according to claim 1, wherein the channel portion has an oblong shape.

7. The dental implant surgical guide device according to claim 1, wherein the channel portion has a length of 37.25 millimeters in the direction perpendicular to the base side.

8. The dental implant surgical guide device according to claim 1, wherein the channel portion has a width of 2.5 millimeters in a direction parallel to the base side.

9. The dental implant surgical guide device according to claim 1, wherein the body portion is formed of a flat sheet.

10. The dental implant surgical guide device according to claim 9, wherein the body portion is formed of stainless steel, tempered spring steel, or plastic.

11. The dental implant surgical guide device according to claim 1, wherein the body portion has a thickness of 0.71 millimeters.

12. The dental implant surgical guide device according to claim 1, wherein the body portion has a thickness of 3 to 4 millimeters.

13. The dental implant surgical guide device according to claim 1, wherein the first tapered side and the second tapered side form an angle of 14.25°.

14. A method for guiding a surgical bur to a center location adjacent to at least one tooth during placement of an implant using a dental implant surgical guide device comprising a triangular body portion having a first tapered side, a second tapered side, and a base side; and a channel portion formed through the body portion and extending in a direction perpendicular to the base side, the method comprising:
positioning the dental implant surgical guide device such that at least one of the first tapered side and the second tapered side abuts the at least one tooth;
passing the surgical bur through the channel portion without contacting the body portion to drill a hole; and
drilling the hole.

15. The method according to claim 13,
wherein the positioning further comprises positioning the dental implant surgical guide device such that the first tapered side abuts a first tooth and the second tapered side abuts a second tooth, and
wherein the at least one tooth comprises the first tooth and the second tooth.

16. The method according to claim 13, the method further comprising reflecting a soft tissue flap prior to positioning the dental device.
